(19) United States
(12) Patent Application Publication
(10) Pub. No.: US 2007/0094266 A1
(43) Pub. Date: Apr. 26, 2007

(54) Collecting information on component implementation and use

(75) Inventors: Ashish Parikh, Issaquah, WA (US); David Brooks, Duvall, WA (US); Henry J. Lyons, Seattle, WA (US); Ram P. Papatla, Sammamish, WA (US)

Correspondence Address: WOLF GREENFIELD (Microsoft Corporation);C/O WOLF, GREENFIELD & SACKS, P.C., FEDERAL RESERVE PLAZA, 600 ATLANTIC AVENUE, BOSTON, MA, 02210-2206, US

(73) Assignee: Microsoft Corporation, Redmond, WA (US)

(21) Appl. No.: 11/253,246

(22) Filed: Oct. 17, 2005

(51) Int. Cl. G06F 17/30; G06F 7/00

(52) U.S. Cl. 707/10

(57) ABSTRACT

Computer-implemented methods and apparatus are provided to determine whether components are implemented by an application executing on a computer. In one embodiment, the application is a server application, and the components define the role(s) performed by the server application in servicing clients. In an exemplary embodiment, an automated process is performed to collect information on the components which are implemented by the application, the components which are in use by the application, the state of the components, and the characteristics of the computer itself. If a user of the computer consents, the information may be transmitted to an information collection facility.

### FIELD OF THE INVENTION

This invention relates to computers deployed in a client-server environment, and more particularly to the automated collection of information stored thereon.

### BACKGROUND OF THE INVENTION

A “server” or “server application” is a software application that is equipped to carry out tasks on behalf of, or provide services to, one or more client applications. One common example of a server application is a web server application, which is equipped to receive requests for information from clients executing a browser application. The web server application processes the requests that are received and provides the information to the client applications.

In general, the services that a server is equipped to perform on behalf of clients correspond to, and are defined by, the modules or components of the server application that are installed or otherwise implemented on the computer(s) on which the server application executes, and the decision of the computer's user to cause such modules or components to be executed, either continuously or on demand. Overall, the services that a server application makes available to clients may be thought of as “roles” which the server performs for the clients.

A server may be equipped to perform a wide variety of roles. For example, depending on the modules of the server application that are installed or implemented, a server may play the role of a file server, print server, mail server, web application server, terminal server, remote access and/or virtual private network (VPN) server, directory services server, streaming media server, or other server role. A server may perform any number of roles at a time.

Conventionally, little reliable information is available regarding the role(s) performed by server applications. This could be because information relating to server role implementation is conventionally collected by surveying customers to determine the roles they have implemented. This manual collection method is inherently flawed, as only a small sample of customers can realistically be surveyed without incurring undue time and expense. In addition, some system administrators, particularly those responsible for multi-server installations, may not have complete and accurate knowledge of the roles implemented on each computer, or have detailed information on how each role is implemented and/or used. As a result, organizations which provide (e.g., sell) server applications may have limited information regarding how server applications are implemented or used by customers.

### SUMMARY OF THE INVENTION

Applicants have appreciated the desirability of access to a greater amount and breadth of information regarding how software components, such as server application modules and/or components, are implemented and used. Access to this information may allow software providers to determine how particular components are implemented and used. As a result, providers may refine their products to make them more useful to customers. For example, if a provider of a server application determines that certain server roles are commonly implemented in combination, the provider may modify the product to allow the roles in question to be more easily combined, or develop new features in one of the roles that complement features in the other. In addition, access to this information may allow software providers to more effectively assist customers in avoiding errors associated with particular component or module implementations. For example, if a provider determines that a particular server role is commonly implemented in a configuration which is ill-suited to support its features (e.g., on a computer with access to insufficient network bandwidth), then the provider may suggest that customers avoid the configuration in question. Numerous other advantages may also be provided via access to this information.

Accordingly, one embodiment of the invention provides an automated technique for collecting information on how application components are implemented and used on a computer. In accordance with one embodiment of the invention, a process is executed periodically on the computer which causes information to be collected, stored electronically, and transmitted to an information collection facility. One particular embodiment which is directed to collecting information on server role implementation and use employs a configuration file which defines server role information to be collected. Based on the configuration file, system sources are queried to collect the server role information. The collected information is stored electronically. If it is determined that the customer has consented to providing the server role information to an information collection facility, then the information is transmitted to the facility. Information is provided anonymously, so that the customer is not identifiable based on the information retained at the information collection facility. In one embodiment, the information that is collected is stored on the computer whether or not it is transmitted to the information collection facility, such that it may be accessed for other analysis (e.g., the customer may query the information to determine the manner in which particular components are implemented or used). This may assist the customer in diagnosing and/or fixing product issues.

### BRIEF DESCRIPTION OF THE DRAWINGS

The accompanying drawings are not intended to be drawn to scale. In the drawings, each identical or nearly identical component that is illustrated in various figures is represented by a like numeral. For purposes of clarity, not every component may be labeled in the drawings:

FIG. 1 is a flowchart depicting an exemplary technique for collecting information related to component implementation and/or use, in accordance with one embodiment of the invention;

FIG. 2 is a block diagram depicting an exemplary system by means of which information related to component implementation and/or use may be collected and/or transported, in accordance with one embodiment of the invention;

FIG. 3 is a flowchart depicting an exemplary technique for implementing an updated configuration file, in accordance with one embodiment of the invention;

FIG. 4 is a block diagram depicting a computer on which aspects of embodiments of the invention may be implemented, and

FIG. 5 is a block diagram depicting an exemplary memory on which aspects of embodiments of the invention may be implemented.

### DETAILED DESCRIPTION

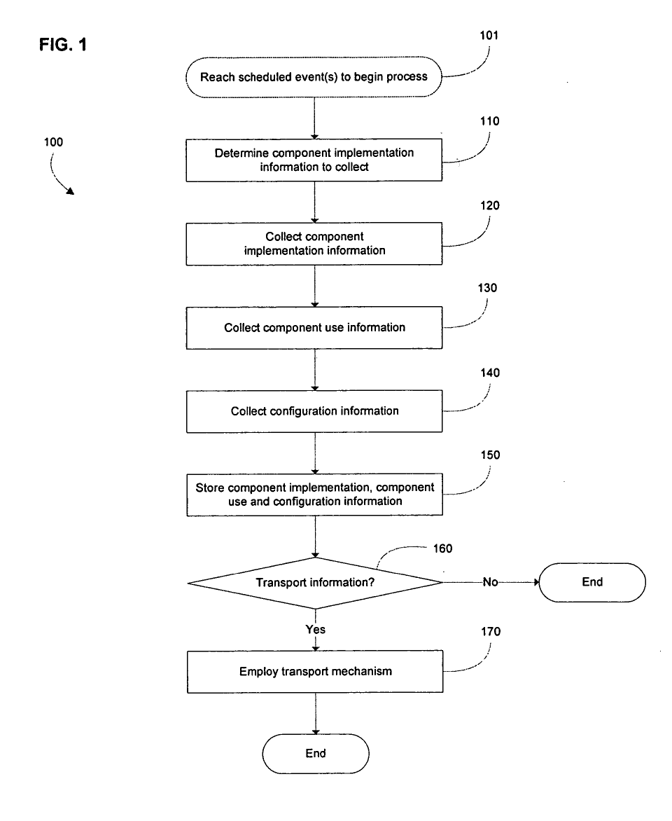

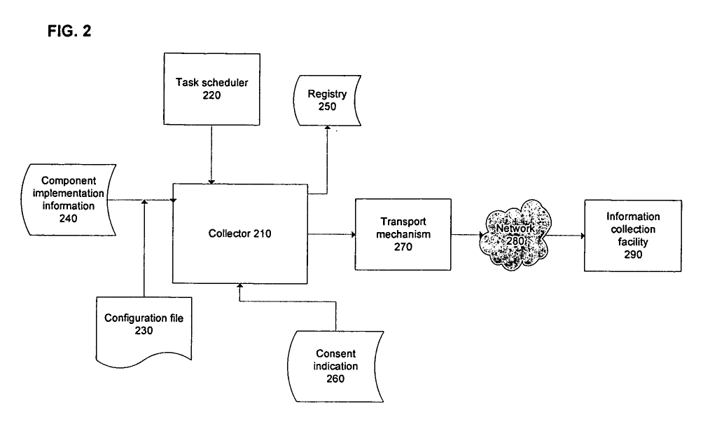

An exemplary method and system for collecting application component information is shown in FIGS. 1 and 2, respectively. At a high level, the exemplary process of FIG. 1 is executed periodically (e.g., as defined by task scheduler 220, FIG. 2) on the computer on which the application executes, and includes determining the component information to collect (e.g., as defined by configuration file 230), collecting the information, storing it (e.g., in registry 250), and, upon determining that the customer has consented to it being provided to an information collection facility (e.g., by examining consent indication 260), transmitting the information to the information collection facility (e.g., facility 290) via a transport mechanism (e.g., transport mechanism 270).

One embodiment of the invention is directed to collecting information relating to the implementation (e.g., installation), use, and/or state (e.g., whether and how often stopped) of various server roles. However, it should be appreciated that the invention is not limited in this respect, as information on any suitable component, implemented and/or used on any suitable system and in any suitable form (e.g., software, hardware, or a combination thereof), may be collected.

To collect information on the implementation, use and state of server roles, a collector application may employ information supplied by a configuration file to query system sources and determine the server roles that are implemented. Upon determining which roles are implemented, the collector application may apply one or more heuristics or rules to determine whether a role that was determined to be implemented is actually running or in use, and/or what its state is and has been since the last time information was collected. Once this data is collected, the collector application may cause it to be stored electronically, such as in the computer's registry. The collector application may then determine whether the customer has consented to the information being sent to an information collection facility. If so, the collector application may employ a transport mechanism to send the information to the facility, so that the information may be analyzed to enhance and refine the server application over time. If not, the process may complete, and the information may be retained (e.g., in the registry) so that it may be accessed by other components, such as an interface employed by the user.

An exemplary process 100 used to collect component information is shown in FIG. 1. As indicated by the dotted lines surrounding act 101, process 100 may be scheduled. For example, process 100 may be set to initiated when a predetermined event occurs, such as when a time is reached. In one embodiment, task scheduler 220 (FIG. 2) may create a task (e.g., in a queue maintained by a server application) and set a time at which the task should begin. This time may, for example, be set such that process 100 kicks off when the processing load on the computer on which it executes is expected to be light. For example, process 100 may be set to begin at 1:00 a.m. local time at the location of the computer, or at another time when the computer is likely to be lightly used. In one embodiment, the time or event which defines the start of process 100 may be modified by a user (e.g., a system administrator). In addition, in one embodiment process 100 may be set to execute periodically, such as nightly.

In addition, in one embodiment process 100 is designed to execute in a manner which conserves processing and/or system resources. For example, process 100 may be configured to restart once upon its failure, so that processing resources are not unduly occupied with attempting to restart process 100 multiple times. Process 100 may also be configured to detect when the computer on which it executes is running on batteries and the battery level is low. If so, process 100 may not execute. A process may accommodate the needs of a particular system in any of numerous ways, as the invention is not limited in this respect.

The process then proceeds to act 110, wherein the component information that is to be collected is determined. In one embodiment, collector 210 (FIG. 2) may access configuration file 230 to determine the component information that is to be collected. Where the component information relates to server roles, configuration file 230 may include information on the various roles which may be implemented or installed in the server application.

An exemplary configuration file defining information that is to be collected relating to server roles is shown below. This exemplary file is provided in XML format, although the invention is not limited to any particular format or implementation. This exemplary configuration file includes XML elements and attributes which are described below.

<?xml version=“1.0” encoding=“utf-8” ?>
<roleDefinitions xmlns=“http://tempuri.org/roleschema.xsd”
version=“1”>

<roleDefinition roleName=“DHCP” roleValue=“1”
roleType=“Role”>

<installTests>

<installTest installType=“Component”

installName=“DHCPServer” />

</installTests >
<runTests>

<runTest testType=“Service”
testParam=“DHCPServer” />

</runTests>

</roleDefinition>
<roleDefinition roleName=“DNS” roleValue=“2”
roleType=“Role”>

<installTests>

<installTest installName=“DNS-Server” />

</installTests>
<runTests>

<runTest testParam=“DNS” />

</runTests>

</roleDefinition>
<roleDefinition roleName=“DFS”
roleValue=“ 0x1000000200000”

roleType=“Subrole”>

<installTests>

<installTest installName=“DFSServer” />

</installTests>
<runTests>

<runTest testParam=“Dfs” />

</runTests>

</roleDefinition>

</roleDefinitions>

The “roleDefinition” element in the configuration file shown above provides basic information for each of the server roles on which information is to be collected. Thus, there is a “roleDefinition” element for each separate role defined in the configuration file. This element includes several attributes, including “roleName,” which provides a name for a role, “roleValue,” which defines an integer value for a particular role (described further below) and “roleType.” The “roleType” attribute defines whether the considered role is a “top-level” role, sub-role (i.e., a feature of a top-level role) or a component (i.e., an optionally installed component of a role). In this respect, those skilled in the art will recognize that certain roles are so widely implemented that identification of sub-roles is particularly useful in determining how the role is implemented. For example, a “file server” role may be so widely implemented that it is not particularly useful to have this information and not also know the type of file server that is implemented. Thus, a file server role may include sub-roles such as DFS, SRM or NFS file servers.

The “installTests” element includes a grouping of one or more “installTest” elements. In one embodiment, each of the “installTest” elements must be satisfied for a particular server role to be considered implemented. An “installTest” element may include “installType” and “installName” attributes. The “installType” attribute defines the type of test which is performed to identify whether the role is implemented. For example, in a Microsoft server application installation, to determine whether certain server roles are implemented, a “Component” install test type may involve querying a Component Based Servicing (CBS) component, an “MSI” install test may involve querying the GUID of the Microsoft Installer (MSI) file, and a “Heuristic” install type may involve invoking a function in a dynamic link library accessible to collector 210, or checking a value stored in registry 250. In a non-Microsoft server application installation, determining whether certain server roles are implemented may involve checking other configuration information, such as a configuration database or one or more text files. The “installName” attribute provides a string which defines query criteria for the considered install test type.

The “runTest” element defines one or more individual “runTest” elements that must each be satisfied for an implemented server role to be considered in use or running. A “runTest” element may include “testType” and “testParam” attributes. The “testType” attribute defines the type of test that is performed to determine whether the role is implemented. In a Windows Server installation, to determine whether certain roles are in use, a “Service” test type may define that a particular service defined by the corresponding “testParam” attribute is to be started to determine whether the considered role is in use. A “Heuristic” test type may define that a Boolean function defined in a DLL accessible to collector 210 is invoked to determine whether the considered role is in use.

It should be appreciated that the configuration file shown above is merely exemplary, and that a configuration file may be defined in any suitable fashion. For example, a configuration file need not be defined using XML, and need not include the specific set of elements and attributes described above.

It should also be appreciated that a configuration file may be provided to process 100 in any suitable manner. For example, a configuration file may be transmitted to the computer on which process 100 executes by an external component (not shown), such as via a network. A configuration file may alternatively be defined manually, such as by an administrator. A configuration file may be defined in any suitable fashion, as the invention is not limited to a particular implementation.

In one embodiment, collector 210 accesses configuration file 230 to determine the component implementation information that is to be collected.

Upon the completion of act 110, the process proceeds to act 120, wherein the component implementation information is collected. In an embodiment wherein the exemplary configuration file shown above is employed, component implementation information may be collected by executing each “installTest” defined therein. In particular, a string defined by the “instalName” attribute may be employed to query the appropriate information source (defined by the “installType” attribute) for the component implementation information. This may be performed in the system of FIG. 2, such that collector 210 employs information provided in configuration file 230 to query component implementation information 240.

Process 100 then proceeds to act 130, wherein information on the use of implemented components (i.e., determined in act 120) is collected. In an embodiment wherein the exemplary configuration file shown above is employed, component use information may be collected by executing each “runTest” defined therein. For example, a string defined by the “testParam” attribute may be employed to either start a service or invoke a Boolean function. This may be performed in the system of FIG. 2, such that collector 210 may start the specified service or invoke the specified DLL to determine whether the considered role is running or in use.

The process then proceeds to act 140, wherein information relating to the computer on which the process executes is collected. In one embodiment, collector 210 issues a series of queries to the computer to determine information such as the operating system version (including major version, minor version, build number, service pack major version and or service pack minor version), operating system boot type, processor family and count, amount of random access memory (RAM), system locale, memory model, and/or other information. This information, if transmitted to an information collection facility, may provide greater insight on the characteristics of the computer on which one or more server roles are implemented. The collection of information relating to the configuration of the computer may be performed in any suitable fashion, including using conventional techniques that are well-understood by those skilled in the art. Any suitable information related to the configuration or characteristics of the computer may be collected.

The process then proceeds to act 150, where component and system information is stored electronically. In one embodiment, collector 210 may cause the information to be stored in registry 250. Component implementation and use information may be stored, for example, in the form of 32-bit bitmaps. For example, a first bitmap may store component implementation (e.g., installation) information, a second may store component use information, and a third may store component state information. Each bitmap may include a series of one-bit indicators or flags which, when set, indicate that a particular role is implemented, in use, and/or stopped. The indicators or flags in respective bitmaps may correspond to one another, such that bit 30 in one bitmap may provide an indication whether a particular component is implemented, and bit 30 in another bitmap may provide an indication as to whether that particular component is in use. However, the invention is not limited in this respect, as information may be stored electronically in any suitable fashion.

In an embodiment of process 100 wherein the exemplary configuration file shown above is employed, information relating to the implementation, use and/or state of a particular server role may be placed in a bitmap at the bit which corresponds to the “roleValue” defined in the configuration file. For example, information relating to “DHCP” role name may be placed in the bitmap at bit 1, which corresponds to the “roleValue” for that role. Thus, bit 1 in one bitmap may provide an indication whether the DHCP role is implemented, and bit 1 in another bitmap may provide an indication that the DHCP role is in use or running. However, the invention is not limited to this or any other particular implementation, as information may be stored in any suitable fashion.

The process then proceeds to act 160, wherein it is determined whether the information should be transmitted to an information collection facility. In one embodiment, this determination is made by collector 210. For example, collector 210 may examine consent indication 260, which may be provided in a data structure and defined by a user's response to a request to provide consent. As an example, the user (e.g., a system administrator) may be prompted to provide consent to send the information when the server application is installed.

If it is determined in act 160 that the information should not be sent, the process ends. However, because the information remains in electronic storage (e.g., registry 250), other components (e.g., components which are not shown in FIG. 2) may access the information. For example, a user may employ an interface to analyze the information, such as to determine components installed or in use on the system.

If it is determined that the information should be sent, the process proceeds to act 170, wherein a transport mechanism is employed to transport the information. In an implementation wherein the Software Quality Metrics (SQM), produced by Microsoft Corporation of Redmond, WA, is installed, SQM may provide this transport mechanism, and may execute periodically to upload information to an information collection facility.

In the embodiment shown in FIG. 2, transport mechanism 270 sends the information via network 280 to information collection facility 290. Once received, information on component implementation and/or use (e.g., collected in acts 120 and 130) may be cross-referenced or otherwise compared to system configuration information (e.g., collected in act 140) to determine characteristics of computers on which certain components are commonly implemented. This analysis may reveal, for example, whether certain system characteristics are ill-suited to a particular component.

Upon the completion of act 170, process 100 completes.

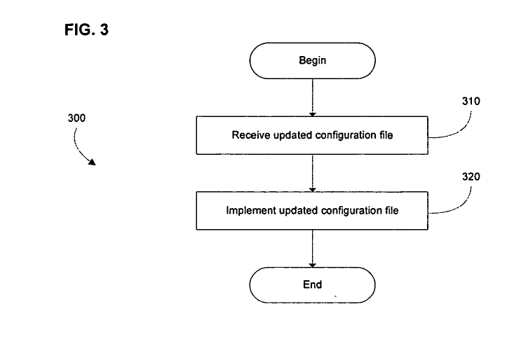

Applicants have appreciated that once information provided in the above-described process is analyzed, users may wish to extract different or additional information for analysis. FIG. 3 depicts a process whereby a configuration file, which defines the information that is to be collected, may be updated on a particular computer.

Upon the start of process 300, an updated configuration file is received in act 310. As examples, a user (e.g., a system administrator) may download an updated configuration file to the computer (e.g., upon being prompted to do so), or manually update the existing configuration file on the computer, or an updated configuration file may be automatically downloaded to the computer use. Any suitable technique for receiving an updated configuration file may be employed, as the invention is not limited to a particular implementation.

Process 300 then proceeds to act 320, wherein the updated configuration file received in act 310 is implemented. For example, application 210 (FIG. 2) may be configured to access the updated configuration file.

Upon the completion of act 320, the process completes.

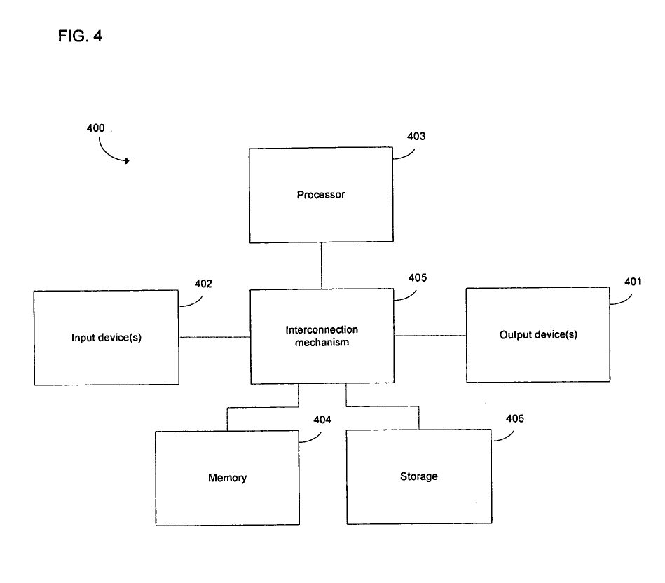

Various aspects of embodiments of the invention may be implemented on one or more computer systems, such as the exemplary system 400 shown in FIG. 4. Computer system 400 includes input device(s) 402, output device(s) 401, processor 403, memory system 404 and storage 406, all of which are coupled, directly or indirectly, via interconnection mechanism 405, which may comprise one or more buses or switches. The input device(s) 402 receive input from a user or machine (a human operator) and the output device(s) 401 display(s) or transmit(s) information to a user or a machine (e.g., a liquid crystal display).

The processor 403 executes a program called an operating system which controls the execution of other computer programs, and provides scheduling, input/output and other device control, accounting, compilation, storage assignment, data management, memory management, communication and data flow control. The processor 403 and operating system define the platform for which application programs and other computer programming languages are written.

The processor 403 may also execute one or more programs to implement various functions, such as those which embody aspects of the invention. These programs may be written in a computer programming such as a procedural language, object-oriented language, macro language, or combination thereof.

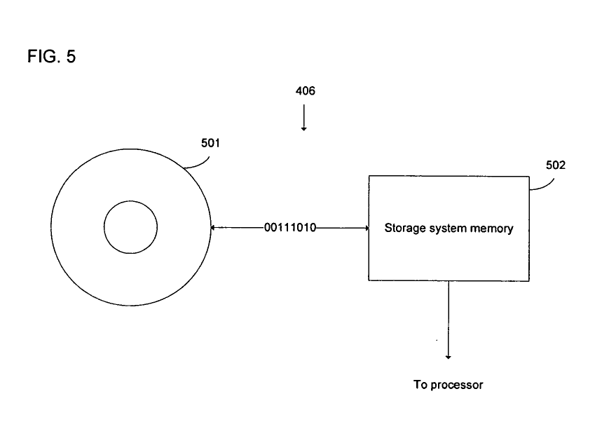

These programs may be stored in storage system 406. The storage system may hold information on a volatile or non-volatile medium, and may be fixed or removable. Storage system 406 is shown in greater detail in FIG. 5. It typically includes a computer-readable and -writable non-volatile recording medium 501, on which signals that define the program, or information to be used by the program, are stored. The medium may, for example, be a disk or flash memory. Typically, in operation, the processor 503 causes data to be read from the non-volatile recording medium 501 into a volatile memory 502 (e.g., a random access memory, or RAM) that allows for faster access to the information by processor 503 than does the medium 501. Memory 502 may be located in storage system 406, as shown in FIG. 4, or in memory system 504, as shown in FIG. 5. The processor 403 generally manipulates the data within the integrated circuit memory 404, 502, and then copies the data to the medium 501 after processing is completed. A variety of mechanisms are known for managing data movement between the medium 501 and the integrated circuit memory 404, 502, and the invention is not limited thereto. The invention is also not limited to a particular memory system 504 or storage system 406.

It should also be appreciated that the above-described embodiments of the invention may be implemented in any of numerous ways. For example, the above-discussed functionality may be implemented using software, hardware or a combination thereof. When implemented in software, the software code can be executed on any suitable processor or collection of processors, whether provided in a single computer or distributed among multiple computers. It should further be appreciated that any component or collection of components that perform the function as described herein may generically be considered as one or more controllers that control the above-described function. The one or more controllers may be implemented in numerous, such as with dedicated hardware, or by employing one or more processors which are programmed using microcode or software to perform the functions recited above. Where a controller stores or provides information for system operation, such information may be stored in a central repository, in a plurality of repositories, or a combination thereof.

Having thus described several aspects of the at least one embodiment of this invention, it is to be appreciated the various alterations, modifications, and improvements will be readily appreciated by those skilled in the art. Such alterations, modifications and improvements are intended to be part of this disclosure, and are intended to be within the spirit and scope of the invention. Accordingly, the foregoing description and drawings are by way of example only.

What is claimed is:

1. In a system comprising a computer in networked communication with a an information collection facility, the computer executing a server application, the server application being operable to implement at least one of a plurality of optionally implemented components, the server application being operable to execute an implemented component, a computer-implemented method comprising acts of:
(A) determining first information defining which of the plurality of components is implemented by the server application; and
(B) transmitting the first information to the information collection facility.

2. The computer-implemented method of claim 1, further comprising an act, performed before the act (B), of determining second information relating to at least one of the execution of an implemented component by the server application and the state of an implemented component, and wherein the act (B) further comprises transmitting the second information to the information collection facility.

3. The computer-implemented method of claim 1, wherein the computer possesses a plurality of characteristics, the method further comprises an act, performed before the act (B), of determining third information defining at least one characteristic of the computer, and the act (B) further comprises transmitting the third information to the information collection facility.

4. The computer-implemented method of claim 1, wherein the computer has a user, and the method further comprises an act, performed before the act (B), of determining that the user has given consent for the first information to be transmitted to the information collection facility.

5. The computer-implemented method of claim 1, wherein at least one of the plurality of components defines a role which is performed by the server application, and wherein the role comprises at least one of a file server, print server, mail server, web application server, terminal server, remote access and/or virtual private network (VPN) server, directory services server, and streaming media server.

6. The computer-implemented method of claim 1, wherein the system further comprises a plurality of computers, the acts (A), (B) and (C) are performed for each of the plurality of computers, and the method further comprises acts of:
(D) aggregating the first and second information which is received from the plurality of computers to produce aggregated information; and
(E) generating at least one report which is based on the aggregated information.

7. The computer-implemented method of claim 1, wherein the act (C) comprises:
(C1) invoking a transport mechanism; and
(C2) transmitting, via the transport mechanism, the first and second information to the information collection facility.

8. At least one computer-readable medium having instructions recorded thereon, which instructions, when executed in a system comprising a computer in networked communication with a an information collection facility, the computer executing a server application, the server application being operable to implement at least one of a plurality of optionally implemented components, the server application being operable to execute an implemented component, perform a method comprising acts of:
(A) determining first information defining which of the plurality of components is implemented by the server application; and
(B) transmitting the first information to the information collection facility.

9. The at least one computer-readable medium of claim 8, further comprising an act, performed before the act (B), of determining second information relating to at least one of the execution of an implemented component by the server application and the state of an implemented component, and wherein the act (B) further comprises transmitting the second information to the information collection facility.

10. The at least one computer-readable medium of claim 8, wherein the computer possesses a plurality of characteristics, the method further comprises an act, performed before the act (B), of determining third information defining at least one characteristic of the computer, and the act (B) further comprises transmitting the third information to the information collection facility.

11. The at least one computer-readable medium of claim 8, wherein the computer has a user, and the method further comprises an act, performed before the act (B), of determining that the user has given consent for the first information to be transmitted to the information collection facility.

12. The at least one computer-readable medium of claim 8, wherein at least one of the plurality of components defines a role which is performed by the server application, and wherein the role comprises at least one of a file server, print server, mail server, web application server, terminal server, remote access and/or virtual private network (VPN) server, directory services server, and streaming media server.

13. The at least one computer-readable medium of claim 8, wherein the system further comprises a plurality of computers, the acts (A), (B) and (C) are performed for each of the plurality of computers, and the method further comprises acts of:
(D) aggregating the first and second information which is received from the plurality of computers to produce aggregated information; and
(E) generating at least one report which is based on the aggregated information.

14. The at least one computer-readable medium of claim 8, wherein the act (C) comprises:
(C1) invoking a transport mechanism; and
(C2) transmitting, via the transport mechanism, the first and second information to the information collection facility.

15. In a configuration in which a computer is in networked communication with a an information collection facility, the computer executing a server application, the server application being operable to implement at least one of a plurality of optionally implemented components, the server application being operable to execute an implemented component, a system comprising:
an implementation information controller operable to determine first information defining which of the plurality of components is implemented by the server application; and
a transmission controller operable to transmit the first information to the information collection facility.

16. The system of claim 1, further comprising an execution and state information controller operable to determine second information relating to at least one of an execution of an implemented component by the server application and a state of an implemented component, and wherein the transmission controller is further operable to transmit the second information to the information collection facility.

17. The system of claim 1, wherein the computer possesses a plurality of characteristics, the system further comprises a configuration information controller operable to determine third information defining at least one characteristic of the computer, and the transmission controller is further operable to transmit the third information to the information collection facility.

18. The system of claim 1, wherein the computer has a user, the system further comprises a consent controller operable to determine whether the user has given consent for the first information to be transmitted to the information collection facility, and the transmission controller transmits the first information to the information collection facility if the consent controller determines that the user has given consent.

19. The system of claim 1, wherein at least one of the plurality of components defines a role which is performed by the server application, and wherein the role comprises at least one of a file server, print server, mail server, web application server, terminal server, remote access and/or virtual private network (VPN) server, directory services server, and streaming media server.

20. The system of claim 1, wherein the transmission controller is further operable to invoke a transport mechanism and transmit, via the transport mechanism, the first information to the information collection facility.
